(19) United States
(12) Patent Application Publication
(10) Pub. No.: US 2009/0000436 A1
(43) Pub. Date: Jan. 1, 2009

(54) Mechanised tailstock assembly for a lathe

(75) Inventors: Tung-Hua Liu, Taichung (TW); Ling-Shih Lan, Taichung (TW)

Correspondence Address: BACON & THOMAS, PLLC, 625 SLATERS LANE, FOURTH FLOOR, ALEXANDRIA, VA, 22314-1176, US

(73) Assignee: VICTOR TAICHUNG MACHINERY WORKS CO., LTD., Taichung (TW)

(21) Appl. No.: 11/819,194

(22) Filed: Jun. 26, 2007

(51) Int. Cl. B23B 23/00

(52) U.S. Cl. 82/148

(57) ABSTRACT

A lathe has a bed, a rack and a mechanized tailstock assembly. The bed has a track having a chamber and a slot. The rack is connected securely to the bed. The mechanized tailstock assembly is movably mounted to the bed and has an outer guide, two moving guiding brackets and a drive device. The outer guide is movably mounted on the bed aligning with the slot. The guiding brackets are respectively connected to the outer guide, extend into the chamber of the track and each guiding bracket has a guide wheel. The drive device is connected securely to the outer guide, engages with the rack and has a casing, a drive axle and a drive wheel. The mechanized tailstock can be moved simply and easily and accurately using the drive device and the guide brackets prevent it from falling away from the surface.

### BACKGROUND OF THE INVENTION

1. Field of the Invention

The present invention relates to a mechanized tailstock assembly, and more particularly to a mechanized tailstock assembly for a lathe which can be used easily and accurately.

2. Description of Related Art

With reference to FIG. 7, a conventional lathe has a bed (80) and a tailstock assembly.

The bed (80) comprises a top and a track (82) and may be formed at an angle to the horizontal. The track (82) is formed longitudinally in the bed (80) at an angle to the horizontal and has a chamber (821) and a slot (822). The chamber (821) is defined in the bed. The slot (822) is formed through the bed (80) and communicates with the chamber (821).

The tailstock assembly is movably mounted on the bed (80) and has an outer guide (83), a brake (84), multiple fasteners and a tailstock (85). The outer guide (83) is movably mounted on the bed (80) and aligns with the slot (822) of the track (82) and has mounting holes, an inner surface and an outer surface. The inner surface abuts the bed (80). The brake (84) is movably mounted in the chamber (821) of the track (82) and has mounting holes that align with the mounting holes of the outer guide (83) through the slot (822). The fasteners are mounted in the mounting holes, connecting the outer guide (83) and the brake (84) to hold the tailstock assembly on the track (82).

The tailstock (85) is used to support long working pieces, is mounted securely to the outer guide (83). When a person wants to move the tailstock (85) relative to the bed (80), the person loosens the fasteners and pushes the outer guide (83) and the brake (84) moving the tailstock assembly along the track (82) to change the position of the tailstock (85).

However, the conventional lathe has the following defects and shortcomings.

1. The tailstock (85) is heavy, and requires much strength and effort to move.

2. In the conventional lathe, the person moves the tailstock (85) by sliding the outer guide (83) and the brake (84) along the track (82) but this is difficult to attain an exact position of the tailstock.

3. Especially if the bed (80) is mounted at an angle from the horizontal, when the fasteners are loosened to move the tailstock (85), the outer guide (83) and the tailstock (85) may lean from the track (82) and be damaged.

The mechanized tailstock assembly for a lathe in accordance with the present invention mitigates or obviates the aforementioned problems.

### SUMMARY OF THE INVENTION

The main objective of the present invention is to provide mechanized tailstock assembly for a lathe that can be easily and accurately moved, whilst mounted securely on a track.

The lathe has a bed, a rack, a mechanized tailstock assembly, two moving guiding brackets and a drive device. The bed has a track having a chamber and a slot. The rack is connected securely to the bed. The mechanized tailstock assembly is movably mounted on the bed and has an outer guide. The outer guide is movably mounted on the bed aligning with the slot of the track. The moving guiding brackets are respectively connected to the outer guide, extend into the chamber of the track and each guiding bracket has a guide wheel. The drive device is connected securely to the outer guide, engages with the rack and has a casing, a drive axle and a drive wheel.

The mechanized tailstock can be moved simply and easily and accurately using the drive device and the guide brackets prevent it from falling away from the surface.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a mechanized tailstock assembly for a lathe in accordance with the present invention;

FIG. 2 is an exploded perspective view of the mechanized tailstock assembly in FIG. 1;

FIG. 3 is an enlarged exploded perspective view of the mechanized tailstock assembly in FIG. 1;

FIG. 4 is a cross sectional front view in partial section of the mechanized tailstock assembly in FIG. 1;

FIG. 5 is an enlarged cross sectional front view in partial section of a drive device of the mechanized tailstock assembly in FIG. 1;

FIG. 6 is an operating side view of the lathe in FIG. 1; and

FIG. 7 is a cross sectional front view of a lathe with a conventional tailstock assembly in accordance with the prior art.

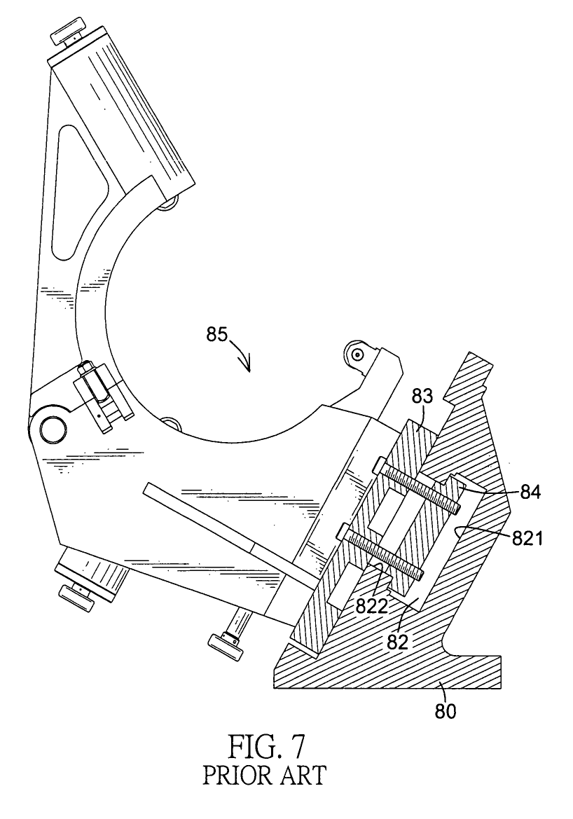

### DETAILED DESCRIPTION OF THE PREFERRED EMBODIMENT

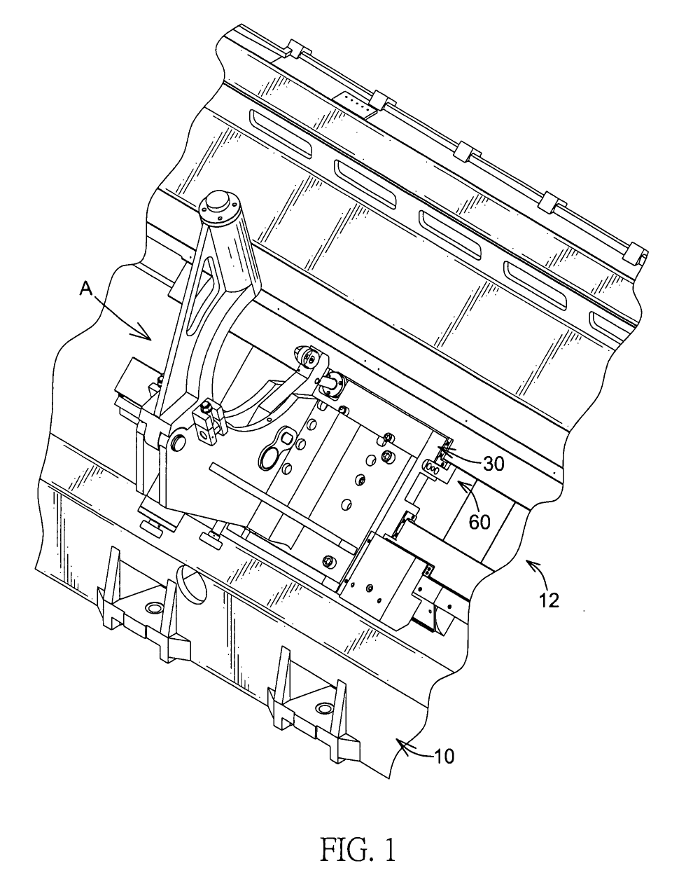

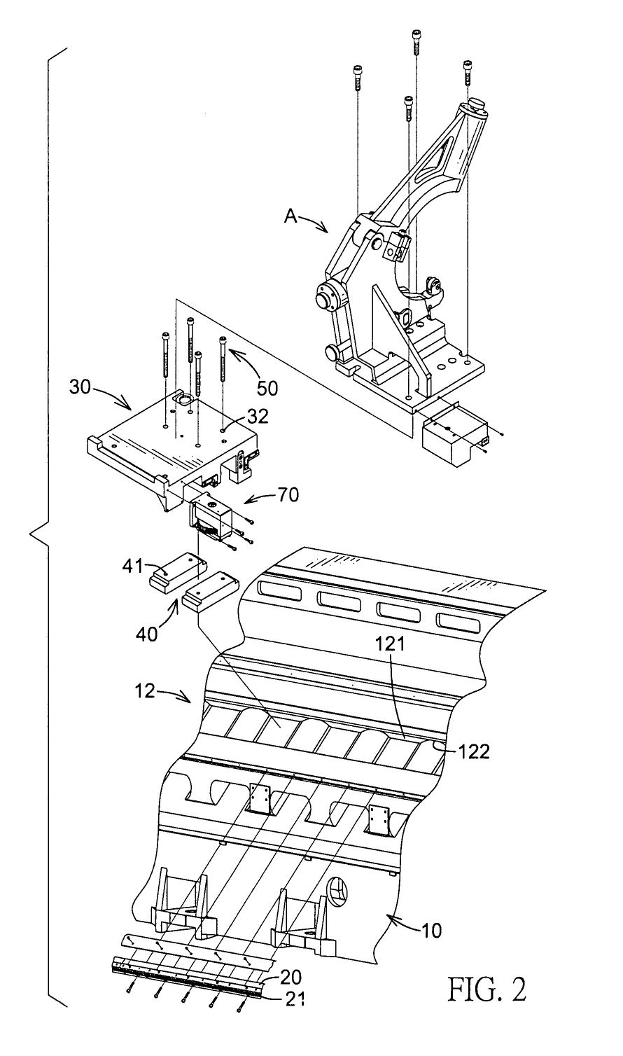

With reference to FIGS. 1 and 2, a lathe in accordance with the present invention comprises a bed (10), a rack (20) and a mechanized tailstock assembly.

The bed (10) may be mounted at an angle from the horizontal and comprises a top, a front end, a rear end, and a track (12). The track (12) is formed longitudinally in the bed (10) and has a chamber (121) and a slot (122). The chamber (121) is defined longitudinally in bed (10). The slot (122) is formed longitudinally through the bed (10) and communicates with the chamber (121).

The rack (20) is mounted securely to the bed (10) and has a mounting surface, an engaging surface and optional multiple teeth (21). The mounting surface of the rack (20) is mounted longitudinally to the bed (10). The teeth are formed on the engaging surface of the rack (20).

The mechanized tailstock assembly is movably mounted on the bed (10) and has an outer guide (30), two brakes (40), four bolts (50), two guiding brackets (60) and a drive device (70).

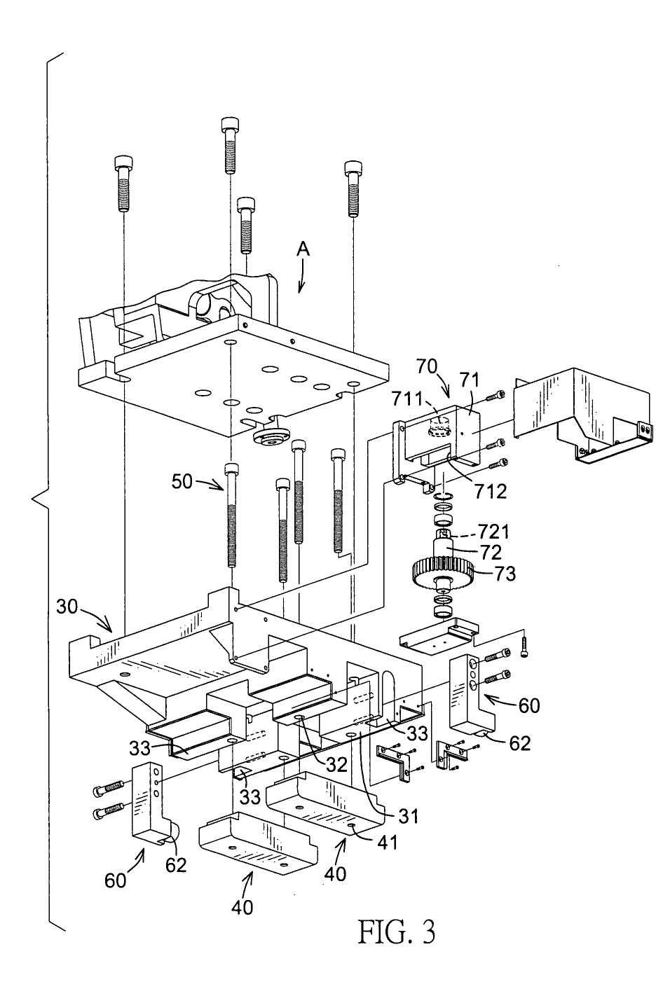

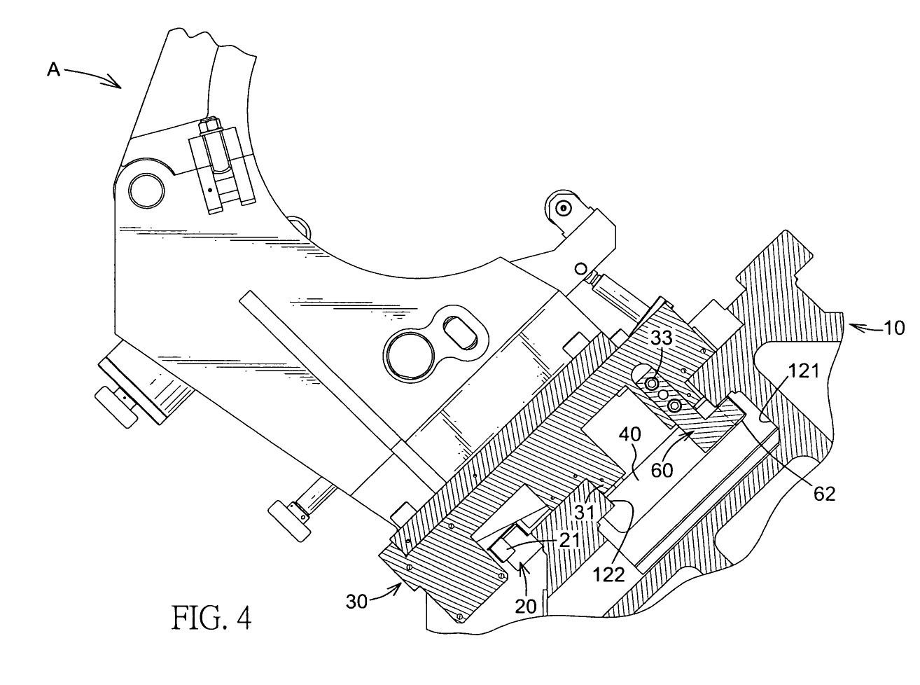

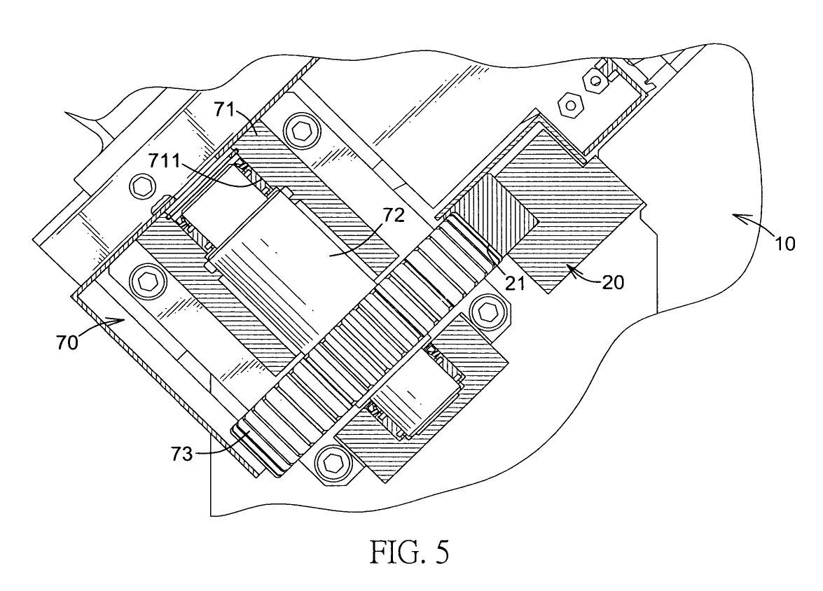

With further reference to FIGS. 3 to 5, the outer guide (30) is movably mounted on the bed (10) between the front end and the rear end, and aligns with the slot (122) of the track (12) and has a mounting surface, a tailstock surface, a front surface, a rear surface, multiple optional mounting protrusions (31), four optional through holes (32) and two optional mounting recesses (33). The mounting surface is mounted on the bed (10). The mounting protrusions (31) are formed on and protrude from the mounting surface of the outer guide (30) and are mounted in the slot (122). The through holes (32) are respectively formed through the mounting protrusions (31) and communicate with the slot (122). The mounting recesses (33) are respectively formed in the front and rear surfaces of the outer guide (30) and respectively through each mounting protrusion (31) and communicate with the slot (122).

The brakes (40) are Movably mounted parallel in the chamber (121), in contact with the track (12) and selectively abut the track (12) to lock or unlock the mechanized tailstock assembly in place and each brake (40) has two bolt holes (41). The bolt holes (41) are formed through a corresponding brake (40) and align with two through holes (32) in the outer guide (30).

The bolts (50) may be threaded, quick release or such like and are mounted through the through holes (32) of the outer guide (30) and the bolt holes (41) of the brake (40) and may be tightened to lock the brakes (40) against the track (12), or loosened to allow the brakes (40) to move along the track (12). Therefore the brakes (40) and bolts (50) act as a locking mechanism.

Each guiding bracket (60) may be L-shaped and has a proximal end, a distal end and a guide wheel (62). The proximal end of the guiding bracket (60) is connected to the outer guide (30) and may be in the corresponding mounting recess (33). The distal end of the guiding bracket (60) extends through the slot (121) and into the chamber (122) and aligns with the track (12). The guide wheel (62) is rotatably connected to the distal end of the guiding bracket (60) and abuts the track (12) near the slot (121).

The drive device (70) is connected securely to the outer guide (30), engages with the rack (20) and has a casing (71), a drive axle (72) and a drive wheel (73). The casing (71) is connected to front surface of the outer guide (30) and aligns with the rack (20) and has a top portion, a gudgeon (711) and a chamber (712). The gudgeon (711) is formed through the top portion of the casing (71). The chamber (712) is defined in the casing (71) and communicates with the gudgeon (711). The drive axle (72) is rotatably mounted in the gudgeon (711) of the casing (71) and has an upper end, a lower end and a keyed recess (721). The upper end of the drive axle (72) extends into the gudgeon (711). The keyed recess (721) may be hexagonallly shaped and is formed in the upper end of the drive axle (72). The drive wheel (73) is mounted around the drive axle (72) in the chamber (712) of the casing (71), engages with the rack (20) and may have teeth that correspond to and engage with the teeth (21) of the rack (20).

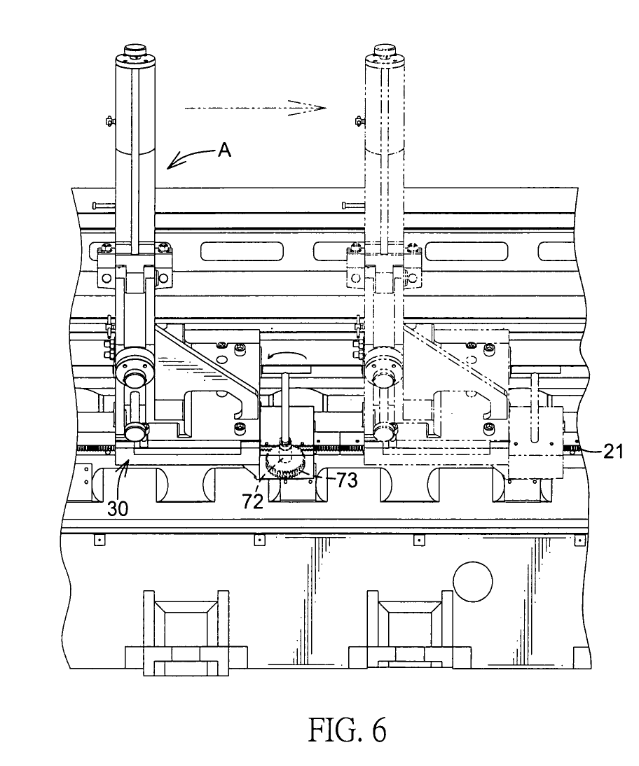

With further reference to FIG. 6, a tailstock (A) is connected securely to the outer guide (30) and is used to support a long working piece. When the position of the tailstock (A) needs to change, a person can loosen the bolts (50) from the brakes (40), and insert a corresponding keyed crank into the keyed recess (721) in the drive axle (72). Rotating the drive axle (72) with the crank, the drive wheel (73) will move relative to the rack (20). Therefore, the drive device (70) and the outer guide (30) can be moved relative to the bed (10) along the track (12) by the drive wheel (71) engaging with the rack (20). After adjusting the position of the outer guide (30) and the tailstock (A) by the drive device (70), the person can fasten the bolts (50) to hold the tailstock (A) securely to the bed (10).

The lathe as described has the following advantages.

1. Users can adjust the position of the tailstock (A) by rotating the drive axle (72) without pushing the outer guide (30) and the brakes (40), and this requires little strength or effort.

2. The tailstock (A) is moved relative to the track (12) by the drive wheel (73) engaging with the rack (20), and this is easy to attain an exact position of the tailstock (A).

3. Especially if the bed (80) is mounted at an angle from the horizontal, when the bolts (50) between the outer guide (30) and the brakes (40) are loosened to move the tailstock (A), the guiding brackets (60) abut the track (12) near the slot (122) to hold the outer guide (30) to the track (12) preventing the tailstock (A) from leaning away from or detaching from the track (12) and being damaged.

Even though numerous characteristics and advantages of the present utility model have been set forth in the foregoing description, together with details of the structure and features of the utility model, the disclosure is illustrative only. Changes may be made in the details, especially, in matters of shape, size, and arrangement of parts within the principles of the invention to the full extent indicated by the broad general meaning of the terms in which the appended claims are expressed.

What is claimed is:

1. A lathe having
a bed having
a top end;
a front end;
a rear end; and
a track being formed longitudinally in the bed and having
a chamber being defined longitudinally in the bed; and
a slot being formed longitudinally through the bed and communicating with the chamber;
a rack being mounted securely to the bed and having
a mounting surface being mounted longitudinally to the bed; and
an engaging surface; and
a mechanized tailstock assembly being movably mounted on the bed and having
an outer guide being movably mounted on the bed between the front end and the rear end, aligning with the slot of the track and having
a mounting surface being faced to the slot;
a tailstock surface;
a front surface;
a rear surface; and
multiple mounting protrusions being formed on and protruding from the mounting surface and being mounted in the slot;
two brakes being movably mounted parallel in the chamber and selectively abutting the track;
multiple bolts being connected to the outer guide and the brakes;
two guiding brackets being respectively connected to the outer guide and each guiding bracket having
a proximal end being connected to the outer guide; and
a distal end extending through the slot into the chamber and against with the track; and
a guide wheel being rotatably connected to the distal end of the guiding bracket and abutting the track near the slot; and
a drive device being connected securely to the outer guide, engaging with the rack and having
a casing being connected to the front surface of the outer guide, aligning with the rack and having
a top portion;
a gudgeon being formed through the top portion of the casing; and
a chamber being defined in the casing and communicating with the gudgeon;
a drive axle being rotatably mounted in the gudgeon and in the chamber and having
an upper end extending into the gudgeon;
a lower end; and
a keyed recess being formed in the upper end of the drive axle; and
a drive wheel being mounted around the drive axle in the chamber of the casing and engaging with the rack.

2. The lathe as claimed in claim 1, wherein the rack further has multiple teeth being formed on the engaging surface of the rack and the drive wheel has teeth that engage with the teeth of the rack.

3. The lathe as claimed in claim 1, wherein
the outer guide has
four mounting protrusions being formed on and protruding from the mounting surface of the outer guide and being mounted in the slot; and
four through holes being respectively formed through the mounting protrusions and communicating with the slot;
each brake has two bolt holes formed through the brake to align with two through holes in the mounting protrusions of the outer guide; and
four bolts being mounted through the through holes of the outer guide and the bolt holes of the brakes.

4. The lathe as claimed in claim 1, wherein
the outer guide further has two mounting recesses respectively being formed on the front and rear surface and communicating with the slot, and
the guiding brackets are mounted in the mounting recesses of the outer guide.

5. The lathe as claimed in claim 2, wherein
the outer guide has
four mounting protrusions being formed on and protruding from the mounting surface of the outer guide and are mounted in the slot; and
four through holes being, respectively formed through the mounting protrusions communicating with the slot;
each brake has two bolt holes formed through the corresponding brake and aligning with two through holes in the outer guide; and
four bolts being mounted through the corresponding through holes of the outer guide and the bolt holes of the brakes.

6. The lathe as claimed in claim 2, wherein
the outer guide further has two mounting recesses respectively being formed in the front and rear surface of the bed and communicating with the slot, and
the guiding brackets being mounted in the mounting recesses of the outer guide.

7. The lathe as claimed in claim 3, wherein
the outer guide further has two mounting recesses respectively being formed in the front and rear surfaces of the bed and communicating with the slot, and
the guiding brackets being connected to the mounting recesses of the outer guide.

8. The lathe as claimed in claim 5, wherein
the outer guide further has two mounting recesses respectively being formed in the front and rear surface of the bed and communicating with the slot; and
the guiding brackets are mounted in the mounting recesses of the outer guide.
